(19) United States
(12) Patent Application Publication
(10) Pub. No.: US 2015/0238286 A1
(43) Pub. Date: Aug. 27, 2015

(54) PAEDIATRIC DENTAL IMPRESSION TRAY

(71) Applicant: Raman Bedi, Potters Bar Hertfordshire (GB)

(72) Inventor: Raman Bedi, Hertfordshire (GB)

(73) Assignee: BEDI ORALCARE, LTD.,, Perthshire (GB)

(21) Appl. No.: 14/432,155

(22) PCT Filed: Oct. 1, 2013
(86) PCT No.: PCT/EP2013/070469

§ 371 Date: Mar. 27, 2015

(30) Foreign Application Priority Data
Oct. 1, 2012 (GB) 1217520.4

(51) Int. Cl. A61C 9/00

(52) U.S. Cl. CPC A61C 9/0006

(57) ABSTRACT

A dental impression tray configured for receiving only a primary anterior dentition, e.g. in a curved channel portion for receiving a dental impression material and the primary anterior dentition therein, for taking a dental impression of a child's primary anterior teeth is capable of significantly improving paediatric compliance in the taking of dental impressions so negating the need for the use of a general anaesthetic.

### FIELD OF THE INVENTION

The present invention relates to a dental impression tray, especially for use with very young children who have primary incisors

### BACKGROUND OF THE INVENTION

It is often desirable to take an impression of teeth in a mouth. This is usually done by placing an impression material in a standard tray, involving all the upper or lower teeth, and then a dentist pushes (places) the tray over the teeth concerned to take the impression.

This technique works well for adults and older children, but pre-school children (typically under six years old), who have primary incisors, will all too often not tolerate the procedure of a dentist's hand in their mouth, a full arch impression or relatively large amounts of impression material in their mouths. To obtain an impression in these circumstances will often only be possible if the child is sedated or under a general anaesthetic.

The invention seeks to provide a solution to this problem and allows for a dental impression of the primary incisors in the dental surgery whilst the child is awake and cooperative.

### PROBLEM TO BE SOLVED BY THE INVENTION

There is a need for improvements in dental trays and dental impression devices which make the dental impression process acceptable for young children without the need for a general anaesthetic.

It is an object of this invention to provide a dental impression tray for paediatric dental impression which overcomes the aforementioned problems.

### SUMMARY OF THE INVENTION

In accordance with a first aspect of the invention, there is provided a dental impression tray configured to receiving an anterior dentition, preferably a primary anterior dentition, more preferably an upper (maxillary) primary anterior dentition and preferably only a primary anterior dentition, for taking a dental impression of a patient's anterior teeth, preferably a child's primary (especially upper) anterior teeth.

In a second aspect of the invention, there is provided a dental impression tray for receiving a dental impression material for taking dental impressions, the tray comprising a curved dental impression channel portion and projecting outwardly therefrom a handle, the channel portion being defined by a curved posterior edge, a curved anterior edge and a recessed inner surface therebetween, the channel portion preferably having a dental impression material receiving volume of up to 15 cm³.

In a third aspect of the invention, there is provided a method of taking a dental impression of a patient's anterior teeth, preferably a child's primary anterior teeth, more preferably a child's upper primary anterior teeth, the method comprising, providing the patient (child) without general anaesthetic with a dental impression tray as defined above, which dental impression tray is provided with a quantity of dental impression material, locating the dental impression tray so as to be engageable with the anterior teeth of the patient (e.g. upper primary anterior teeth of the child), instructing the patient (child) to gently bit on the dental impression tray so as to move the tray into an impression position in which the anterior teeth (e.g. upper primary anterior teeth) are immersed in the impression material, maintaining the impression position for a curing period, optionally instructing the patient (e.g. child) to release the bite and removing the impression tray from the anterior teeth (e.g. upper primary anterior teeth).

In a fourth aspect of the invention, there is provided a method of manufacture of a dental impression tray as defined above, the method comprising providing a mould for a dental impression tray as defined above, placing in the mould, e.g. by injection moulding techniques, a curable material such as a thermoplastic elastomer, causing the curable material to cure to form a dental impression tray as defined above and relesasing the dental impression tray from the mould.

In a fifth aspect of the invention, there is provided a mould for use in a method of manufacturing as defined above.

In a sixth aspect of the invention, there is provided a dental impression tray for primary incisors which is preferably smaller (as primary incisors are significantly smaller in both height and width compared to permanent incisors) in size as it only takes the impression of the anterior primary teeth and smaller in depth as only the primary incisors are involved.

### ADVANTAGES OF THE INVENTION

The dental impression tray of the present invention enables an impression of the maxillary primary anterior dentition of a child to be taken without undue comfort normally associated with the taking of dental impressions and without the need for a general anaesthetic because the tray is ideally configured only to receive the upper primary anterior dentition, and receives a relatively small quantity of impression material which reduces discomfort and reduces the likelihood of gag reflex, and because the child may feel more control of the process by initiating the impression tray engagement with their bite, which helps properly engage the upper primary anterior dentition in impression material located in the tray.

### BRIEF DESCRIPTION OF THE DRAWINGS

FIG. 1 illustrates one embodiment of the dental impression tray of the present invention in a perspective view;

FIGS. 2A and 2B illustrate cross sectional views of the tray of FIG. 1 showing how upper and lower teeth of a user engage with the tray during the taking of a dental impression of the upper dentition; and

FIG. 3A and FIG. 3B illustrate cross sectional views of the tray of FIG. 1 showing how upper and lower teeth of a user engage with the tray during the taking of a dental impression of the lower dentition.

### DETAILED DESCRIPTION OF THE INVENTION

The dental impression tray of the present invention is intended for a dental patient who is uncomfortable with the dental impression process but requiring a dental impression of at least the anterior dentition. It is particularly directed toward patients who are children (in particular children of 12 years or under and more particularly 8 years and under, e.g. 6 years and under) and in particular it is preferably intended for children having a primary dentition. Hereinafter, the dental impression tray and methods of the invention will be described according to preferred embodiment with particular reference to the preferred embodiment in which it is configured for taking the dental impression of a child's primary anterior dentition and more preferably a maxillary (upper) primary anterior dentition. However, it should be understood where the context allows that such features are disclosed also with reference to patients with mixed primary and secondary dentitions and with secondary dentitions where the anterior dentition impression is desired.

The dental impression tray of the present invention is preferably configured to receiving a primary anterior dentition, more preferably an upper primary anterior dentition, preferably only a primary anterior dentition, and/or comprises a dental impression channel portion comprising a material receiving volume of up to 15 cm³.

Preferably, the dental impression tray is configured to receive a primary anterior dentition in a curved channel portion defined by a posterior edge and an anterior edge and therebetween a channel wall defining a recessed inner surface. Preferably the recessed inner surface is concave between the posterior and anterior edges (and preferably from the posterior to the anterior edge).

Preferably, the dental impression tray is for taking the dental impression of the maxillary primary anterior dentition.

Preferably the channel wall has an outer surface which comprises an inclined posterior surface against which a child may bite with the teeth opposing the dentition of which the impression is being taken. The inclined surface in use will preferably incline in a direction from posterior to anterior (e.g. relative to an impression material plane, i.e. a material fill plane).

By providing an inclined posterior outer surface (e.g. on the other side of the tray from the channel opening) which inclines in a direction from posterior to anterior, the dental impression tray is configured to take a dental impression of the upper anterior dentition in particular. The inclined surface may be engaged by the mandibular (lower) teeth to push the dental impression tray containing dental impression material up onto the maxillary dentition so that the maxillary anterior teeth are located in the channel. An incline in a direction from posterior to anterior on the outer surface of the tray enables the impression tray to be pushed in the appropriate direction by the lower teeth to take a good accurate impression of the upper teeth. Such an inclined surface would not aid the taking of mandibular dental impressions because the application of force by the upper teeth on the inclined surface would not push the tray onto the lower teeth in the correct direction and would not create a good impression. Accordingly, this embodiment is particularly suited (and particularly configured) for taking the dental impression of a maxillary anterior dentition.

Preferably, the tray further comprises a handle projecting outwardly from the channel portion. The handle preferably projects outwardly from a medial location of the channel portion.

As mentioned above, it is preferable that the dental impression tray is configured to receive only a primary anterior dentition in a curved channel portion formed therein. Preferably, the channel portion is configured to receive a volume of material sufficient to provide a depth such that the crowns of the anterior teeth are immersed in dental impression tray when in an impression position.

Preferably, the dental impression tray does not take (is not capable of taking) a dental impression of the posterior dentition, i.e. it does not have a posterior dentition impression portion.

Preferably, the dental impression tray does not take (is not capable of taking) an impression of the palate, i.e. there is no palate impression portion.

Preferably, the dental impression tray consists essentially of a curved channel portion configured to receive, for taking a dental impression, a primary anterior dentition and a handle projecting outwardly from a medial position of the channel portion.

The dental impression tray is preferably a single unitary moulded article, preferably of thermoplastic elastomer.

By anterior dentition, it is intended to include the central incisors, lateral incisors and cuspids (or canines). It is not intended to include the molars (in terms of a primary dentition) which would be the posterior dentition or in the case of secondary dentition the pre-molars or molars (which again would form the posterior dentition).

The channel portion is preferably generally arcuate or partially U-shaped (in plan). The channel portion preferably extends from a lateral periphery to an opposing lateral periphery, which lateral peripheries typically comprise open ended profile ends of the channel.

The length of the channel may be taken as the distance from the lateral peripheral edge to opposing lateral peripheral edge following the curve of the channel, which may preferably be taken as the central line on the inner surface of the channel (e.g. equidistant between the posterior and anterior edges).

Preferably, the channel portion has a length of up to 50 mm, more preferably up to 45 mm, preferably at least 25 mm and most preferably in the range 30 to 40 mm, e.g. about 35 mm (for example from 34 to 38 mm). The direct distance between lateral peripheral edges is preferably up to about 45 mm, e.g. up to about 40 mm, preferably at least 20 mm, and most preferably from about 30 to 35 mm.

Width of channel is the distance from the posterior to the anterior edge, typically consistent along the length of the channel. Preferably, the width of the channel is up to about 20 mm, more preferably up to about 15 mm, preferably at least 5 mm, more preferably at least 7 mm, and most preferably 8 to 12 mm, e.g. about 10 mm. The channel is ideally sized to minimize the size of the tray that the patient has to put up with being placed in their mouth and necessary to receive the teeth, whilst large enough to ensure that there is adequate material to take a dental impression whilst allowing for the variations in anterior arch shapes and to make taking the dental impression relatively straightforward. It is found that the optimum width for this purpose is up to about 15 mm, preferably about 8-12 mm.

Depth of the channel may be taken as the distance from the central line of the inner surface of the channel (e.g. equidistant from the posterior and anterior edges) and a plane [which may be referred to as the material fill plane] including the posterior edge and optionally the anterior edge or a position on an inner facial surface of the channel to which impression material may be filled. A position to which the impression material may be filled, if not the anterior edge, may be marked on the inner facial surface of the channel, e.g. by a line or ledge (to assist with leveling).

Preferably, the depth of the channel is up to about 20 mm, more preferably up to about 14 mm, more preferably up to about 12 mm, preferably up to about 10 mm, preferably at least about 6 mm and most preferably in the range of about 7 to 9 mm. The depth again should be selected to maximize the utilization of dental impression material in the taking of the impression whilst minimizing the size of device to be placed in the patient's mouth yet making the process of taking the impression reliably achievable first time. It is believed that the average maximum crown height of a primary central incisor is about 6 mm, so that is the typical maximum depth that needs to be accommodated. It is found that the above range is particularly useful in achieving these objectives. By having a depth defined by the plane including the posterior edge and a position on the inner facial surface of the channel, longer teeth can be accommodated by using the device with a slightly deeper amount of material—i.e. by filling the channel to slightly closer to the anterior edge.

The curvature of the channel may be any suitable to achieve the preferred engagement with the patient's anterior dentition. The curvature may be defined as the radius of the best fit curve to the central line of the channel, as defined above. Preferably, the best fit curve has a radius of from 15 to 25 mm, more preferably 17 to 22 mm and preferably up to about 20 mm.

In a preferred embodiment of the invention, the dental impression tray is particularly characterised by the volume of dental impression material it is configured to contain. Preferably, the channel may contain a volume of up to 15 cm³, more preferably up to about 10 cm³ (e.g. in one embodiment in the range 5 to 10 cm³), preferably at least 1 cm³, for example up to about 5 cm³, more preferably in the range 1.5 cm³ to 3 cm³, e.g. 1.5 to 2.5 cm³.

In a particularly preferred embodiment, the tray has a channel having a length of 30 to 40 mm, a width of 8 to 12 mm and a depth of 7 to 9 mm, preferably with a curvature of about 17 to 22 mm. Preferably, a channel according to the preferred embodiment is capable of receiving a volume of impression material of from 1.5 cm³ to 4.5 cm³, preferably 2.5 cm³ to 3.5 cm³.

The channel walls preferably have a typical thickness, e.g. at the lingual portion of the walls of from 0.15 to 0.5 mm, more preferably 2 to 3.5 mm.

Preferably, the handle extends generally outwards (or anteriorally) from the channel portion and is medially located. Typically, the handle will be an elongate member extending outward from the channel portion, being a generally cylindrical (e.g. circular profile) or tapered protrusion, although it may be of any suitable profile. The handle may extend from the channel portion typically by about 10 to 30 mm, preferably at least 15 mm, e.g. about 20 to 25 mm. The handle preferably has a width and/or height of about 4 mm, e.g. from 5 to 20 mm. For convenience and comfort in use, the handle may extend in a direction generally parallel with the material fill plane. In particular, it is preferred that the apical surface (i.e. the upper surface when the tray is held such that the channel is facing upwards) is generally coplanar with the material fill plane (e.g. generally coincident and within about up to 15 degrees of coplanar) and the junction between the apical plane and the channel portion is generally coincident with the position on an inner facial surface of the channel to which impression material may be filled (which, if not the anterior edge, may optionally be marked on the inner facial surface of the channel, e.g. by a line or ledge).

In one particular embodiment, the handle may be configured to have an indented oval profile, the oval having a larger lateral dimension and an indentation in at least the apical surface for receipt in use of the user's thumb, to better improve the grip. Thus, the handle will be preferably provided with a channel for receipt of the thumb in the apical surface of the handle extending at least partly along its length from an anterior end, and typically decreasing in the degree of indentation toward the posterior of the handle. The coronal surface of the handle may optionally be provided with a lateral groove or ridge for receiving contact with the index finger of the user when holding the tray, to improve balance and steadiness of the tray for the holder of the tray when in use, thereby achieving more reliable dental impressions. Preferably, the handle according to this embodiment will extend longitudinally from the channel portion to produce a handle of at least 4 10 mm in length, preferably at least 15 mm, more preferably from 20 to 25 mm. The width (transverse lateral dimension) of the handle of this embodiment at its anterior end may be from 4 to 30 mm, e.g. 5 to 20 mm, preferably at least 15 mm. The height (vertical dimension) of the handle of this embodiment at its anterior end may be up to about 15 mm, preferably up to about 10 mm, with the indented portion reducing that height by or to about 5 mm. These features of the handle configuration are particularly applicable to those embodiments of the invention directed particularly to taking maxillary anterior dental impressions, which is the most common dental impression taken of primary teeth.

Preferably, the channel has an outer surface which is generally convex (to correspond with an inner concave surface), but is as mentioned above preferably provided with an inclined surface inclining in a direction from posterior to anterior. This inclined surface is intended in particular for the child to bite the opposing (mandibular) teeth against to assist in engaging the tray onto the maxillary dentition to be impressed. The inclined surface should be configured therefore for comfortable abutment by the opposing (mandibular) teeth, in particular the primary central incisors and optionally also the primary lateral incisors.

By inclined surface from posterior to anterior, it is meant that a point on the outer surface toward the posterior of the tray is close to a material fill plane, as defined above, (or the longitudinal axis, or apical surface plane, of the handle, in the alternative) than a point, up the inclined surface, toward the anterior of the tray. In other words, when the tray is laid channel-down on a platform with the handle roughly parallel with the platform, the inclined surface visibly inclines from posterior to anterior.

The inclined surface will typically have an angle of inclination of up to 45°, preferably up to 30° to the plane of the impression material fill (i.e. a plane defined by the posterior edge and either the anterior edge or a position on the inner facial surface of the channel to which impression material may be filled, as defined above), or to the longitudinal axis of the handle. Preferably the inclined surface is at least 5° to the plane of the impression material fill (or longitudinal axis of the handle). Preferably, the inclined surface has an angle of inclination in the range 5° to 30°, e.g. from 10° to 15° or 30° or from 5° to 10°. The inclined surface may be planar or may be curved, in which case it may decrease in angle to the material fill plane from posterior to anterior (and the most relevant angle may be taken as that angle approaching the central line of the channel).

The inclined outer surface area (or bite surface) preferably includes at least an area from posterior of a central line (of the channel) to the central line or anterior of the central line (e.g. from 5 mm posterior of the central line up to the central line or up to 5 mm anterior of the central line).

The dental impression tray of the present invention may comprise any suitable curable material, typically comprising a curable polymer material. For example, the dental impression tray may comprise polypropylene, polyethylene, high density polyethylene, polytetrafluoroethylene, polycarbonate, acrylic, nylon, ABS or PVC. Preferably, the material is a self-supporting resilient but flexible material for improved comfort for the user and for ease of removal of the cured dental impression material from the channel. Preferably, the dental impression tray is manufactured from a thermoplastic elastomer. The selected thermoplastic elastomer is preferably effective for injection moulding manufacturing techniques. Optionally, the tray is provided with an overmoulded portion, e.g. for the handle portion, in order to provide functional surface features of the handle (such as those described below).

Optionally, the impression tray is a single use article.

Optionally, the impression tray is provided with a releasable flavouring material to enhance the experience and improve compliance amongst patients. The releasable flavouring material may be incorporated by any suitable means. For example, the flavouring material, comprising a flavouring excipient, may be included in the material of the tray during manufacture and configured to leach out from the material; may be included in an outer coating included in a secondary mould step during manufacture or in a dip coating process after manufacture of the article; or it may be included by spraying or coating of a formulation of a flavouring material directly onto the outer surface of the channel portion of the tray, e.g. on the lingual portion of the tray, which formulation is configured to stick and harden to the tray.

Any suitable flavouring excipient may be used. For example, natural flavourings may be used, such as peppermint oil, lemon oil or orange oil, or an artificial flavouring may be used. Preferably, a natural flavouring exipient is used.

Preferably, the flavouring is incorporated by microencapsulated flavouring particles provided in a soluble adhesive formulation on at least the lingual portion of the tray.

Any suitable encapsulant, e.g. food or medical grade, may be used, such as Arabic gum, maltodextrin or modified starches such as N-lok™ or a mixture thereof. The flavouring may be encapsulated in the encapsulant by spray freeze-drying a homogenized mixture thereof according to known techniques. The microencapsulated particles may then be applied to an adhesive coating on the tray or formulated in a carrier that may be adhered to the outer surface of the tray.

Optionally, a sweetener, natural (such as sorbitol) and/or artificial (such as sucralose), may be added.

By lingual portion, it is meant in use that portion of the device that is on the lingual side of the teeth when the teeth are engaged on the tray.

The dental impression tray may be manufactured by any suitable method. Preferably it is manufactured by injection moulding. Accordingly, a mould may be prepared, placing in the mould a curable material such as a thermoplastic elastomer, causing the curable material to cure to form a dental impression tray according to the invention and relesasing the dental impression tray from the mould.

The dental impression tray of the present invention is typically to be used by children. The dentist will typically fill the channel of the dental impression tray with a dental impression material (typically an alginate) to the desired level. The patient will typically be encouraged to assist whilst the dentist, holding the handle of the tray, aligns the channel with the upper or lower anterior dentition for which an impression is desired (typically the upper, for which the preferred embodiment of the tray is particularly configured). The patient may then take hold of the handle and on instruction by the dentist bite the opposing teeth against the outer surface of the channel causing the anterior dentition to be impressed into the dental impression material, typically until the crowns are immersed in material. The tray must be held in this impression position for a period of time until the impression material is cured sufficiently to be removed. The dentist will typically assist in removing the device from the patient's teeth. By the use of a tray for receiving only the anterior teeth and having a relatively low volume of dental impression material, the unpleasant overflow of significant amounts of material is avoided, especially at the back of the mouth where the gag reflex may otherwise be initiated. Further, by engaging only with the anterior dentition, protrusion of both a tray and the dentist's fingers far into the mouth is avoided. Thus discomfort associated with the process is minimized. The use of the device as described without a palate engaging portion also improves the comfort for the user.

In a further aspect, as mentioned above, and preferred embodiment a dental impression tray for primary incisors is smaller (as primary incisors are significantly smaller in both height and width compared to permanent incisors) in size as it only takes the impression of the anterior primary teeth and smaller in depth as only the primary incisors are involved. The impression tray comprises a substantially U-shaped curved channel having a concave inner wall and a generally convex outer wall, one part of the convex outer wall presenting an inclined surface, and the other part of the of the convex outer wall supporting an outwardly directed handle. In use, impression material can be placed in the inner wall section of the curved channel and the tray placed in an open mouth with the handle extending out of the mouth and held by a user and with the curved channel adjacent upper or lower teeth which need an impression taken of them, and when the upper and lower teeth are brought together, the lower or upper teeth engaging the inclined surface so forcing the tray forwards and upwards or downwards. This inclined tray allows the child to locate the impression tray and material in the correct position. Preferably the tray is formed as a unitary moulding of plastic.

The invention will now be described in more detail, without limitation, with reference to the accompanying Figures.

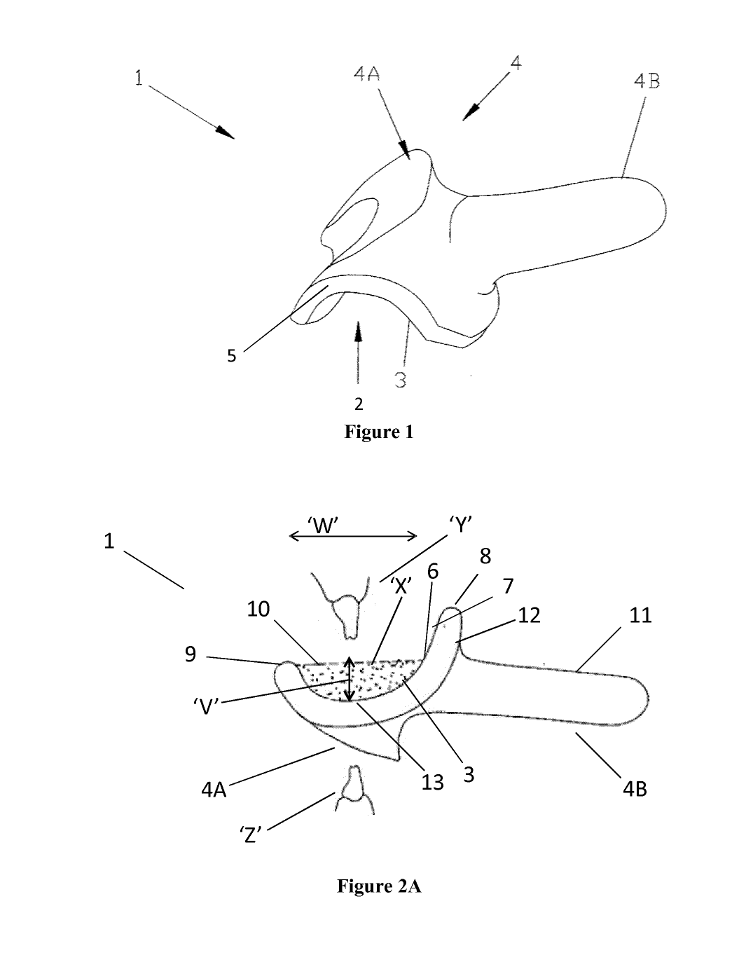

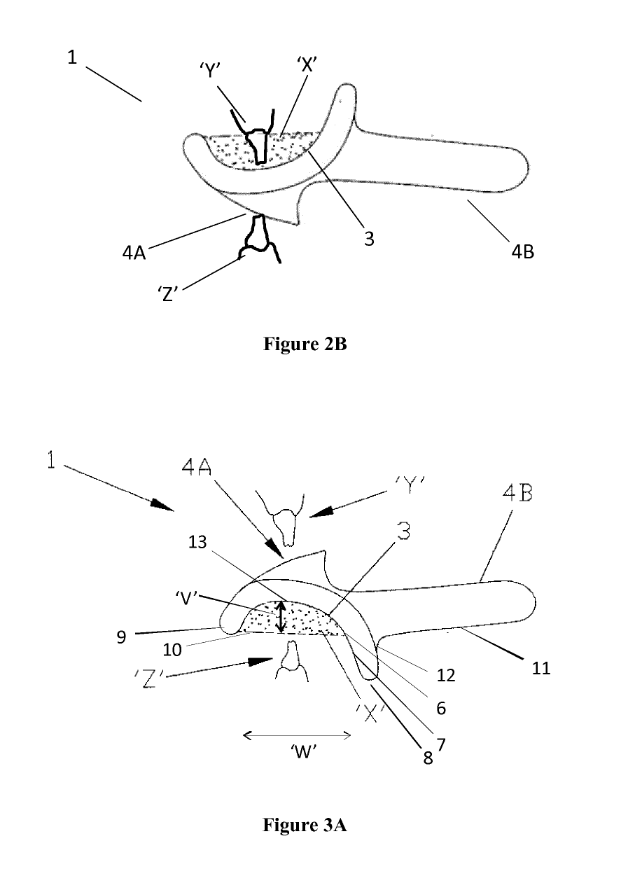

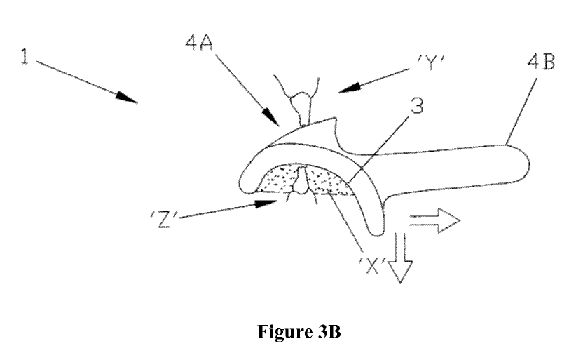

The FIGS. 1 to 3 illustrate a dental impression tray 1 according to a preferred embodiment having an outwardly inclined outer surface 4A. FIGS. 2A and 2B illustrate its use for the optimal purpose of taking a dental impression of an upper (maxillary) tooth Y, whilst FIGS. 3A and 3B illustrate an alternative less optimal use in taking a mandibular (Z) dental impression. Whilst non-optimal, this particular embodiment can be used in this way.

As illustrated in FIG. 1, a dental impression tray 1 formed as a unitary moulding of plastics material (e.g. thermoplastic elastomer) has a curved channel 2 with concave inner wall (or surface) 3 and convex outer wall (or surface) 4. The channel 2 may be defined by posterior edge 9 and anterior edge 8 with recessed inner concave surface 3 surface extending therebetween. One part of the convex outer surface (approximately half the outer wall) presents an inclined surface 4A, and the other part of the convex outer surface supports an outwardly directed handle 4B. The channel 2 extends from lateral perphieral edge 5 to lateral peripheral edge (not shown) to an extent of about 25 to 45 mm typically.

As shown in FIGS. 2A and 2B, impression material X can be placed in the inner wall section of the curved channel 2 and the tray placed in an open mouth between upper and lower teeth Y and Z. The impression material X is filled to a fill level 6 on the inner facial surface 7 a distance from anterior edge 8. The impression material X then defines an impression material fill plane 10 defined between posterior edge 9 and fill level 6. The apical surface 11 of the handle 4B abuts the channel outer wall 4 at a joining point 12 generally coincident with the fill level 7. The channel 2 may be defined as having a width W, being the distance between posterior edge 9 and anterior edge 8 (or in the alternative posterior edge 9 and fill level 7), which may preferably be from 8 to 12 mm. The channel 2 may be defined as having a depth V, being the distance between the channel base 13 (typically at the central line of the channel) and the material fill plane 10, which may preferably be from 7 to 9 mm. In use, the handle 4B extends out of the mouth and is held by a user such as the child patient or their parent, with the curved channel 2 adjacent upper primary anterior teeth Y which need an impression taken of them. When the upper and lower teeth Y,Z are brought together, the lower anterior teeth engage the inclined surface 4A so forcing the tray upwards at an angle to that enables the upper teeth Y to be imbedded and the crowns immersed in the impression material X. Due to the angle of the inclined surface 4A, the tray is moved onto the upper teeth Y such that a good impression can be taken. The impression material X is allowed to set forming an impression of upper teeth Y, and the tray is then removed.

As shown in FIGS. 3A and 3B, a device can be used less optimally also to take impression of the lower teeth Z. Again, impression material X can be placed in the inner wall section of the curved channel 2 and the tray placed in an open mouth between upper and lower teeth Y and Z. The impression material X is filled to a fill level 6 on the inner facial surface 7 a distance from anterior edge 8. The impression material X then defines an impression material fill plane 10 defined between posterior edge 9 and fill level 6. The apical surface 11 of the handle 4B abuts the channel outer wall 4 at a joining point 12 generally coincident with the fill level 7. The channel 2 may be defined as having a width W, being the distance between posterior edge 9 and anterior edge 8 (or in the alternative posterior edge 9 and fill level 7), which may preferably be from 8 to 12 mm. The channel 2 may be defined as having a depth V, being the distance between the channel base 13 (typically at the central line of the channel) and the material fill plane 10, which may preferably be from 7 to 9 mm. In use, the handle 4B extends out of the mouth and is held by a user such as the child patient or their parent, with the curved channel 2 adjacent lower primary anterior teeth Z which need an impression taken of them. When the upper and lower teeth Y,Z are brought together, the upper teeth engage the inclined surface 4A so forcing the tray forwards and downwards as shown by the arrows. Ideally, the dentist or parent may assist with this in holding the handle and applying appropriate pressure to ensure a good impression is taken. The impression material X is allowed to set forming an impression of lower teeth Z, and the tray is then removed.

The design of the tray allows for use of less impression material than hitherto known trays. The tray allows a child to bite on the impression material without the tray being held by a dentist.

The invention has been described with reference to a preferred embodiment. However, it will be appreciated that variations and modifications can be effected by a person of ordinary skill in the art without departing from the scope of the invention.

1. A dental impression tray configured for receiving only a primary anterior dentition for taking a dental impression of a child's primary anterior teeth.

2. The dental impression tray as claimed in claim 1, which comprises a dental impression curved channel portion, which channel portion is configured to receive the primary anterior dentition.

3. The dental impression tray as claimed in claim 2, wherein the dental impression curved channel portion is defined by a posterior edge, an anterior edge and a recessed inner surface extending therebetween.

4. The dental impression tray as claimed in claim 2, wherein the dental impression curved channel portion has a dental impression material receiving volume of up to 15 cm³, preferably up to 5 cm³.

5. The dental impression tray as claimed in claim 2, wherein the channel following a curve from a first lateral peripheral edge to a second lateral 20 peripheral edge has a length of from 25 to 50 mm, preferably 30 to 40 mm.

6. A The dental impression tray as claimed in claim 2, wherein the channel has a width of up to 20 mm, preferably 8 to 12 mm.

7. The dental impression tray as claimed in claim 2, wherein the channel has a depth of from 6 to 12 mm.

8. The dental impression tray as claimed in claim 2, comprising a handle projecting outwardly from a medial location of the channel portion.

9. The dental impression tray as claimed in claim 2, which is configured for taking a dental impression of a maxillary primary anterior dentition.

10. The dental impression tray as claimed in claim 2 wherein the channel has an outer surface which defines an inclined surface which in use may be aligned for engagement by the opposing teeth to those needing impression, the inclined surface inclining in a direction from posterior to anterior.

11. The dental impression tray as claimed in claim 10, wherein the inclined
surface has an angle of inclination of up to 30° to an impression material fill plane,
being the plane defined by impression material filled in the channel for use.

12. The dental impression tray as claimed in claim 1, which is a unitary moulded article of thermoplastic elastomer.

13. A The dental impression tray as claimed in claim 1, which is provided with a releasable flavouring material.

14. The dental impression tray as claimed in claim 13, wherein the releasable flavouring material comprises a microencapsulated flavouring excipient coated onto at least a posterior outer surface of a lingual portion of the tray.

15. (canceled)

16. A method of taking a dental impression of a patient's anterior teeth, preferably a child's primary anterior teeth, the method comprising, providing the patient (child) without general anaesthetic with a dental impression tray of claim 1, which dental impression tray is provided with a quantity of dental impression material, locating the dental impression tray so as to be engageable with the anterior teeth of the patient (e.g. primary anterior teeth of the child), instructing the patient (child) to gently bit on the dental impression tray so as to move the tray into an impression position in which the anterior teeth (e.g. primary anterior teeth) are immersed in the impression material, maintaining the impression position for a curing period, optionally instructing the patient (e.g. child) to release the bite and removing the impression tray from the anterior teeth (e.g. primary anterior teeth).

17. A method of manufacture of a dental impression tray as defined above, the method comprising providing a mould for a dental impression tray as defined in claim 1, placing in the mould, e.g. by injection moulding techniques, a curable material such as a thermoplastic elastomer, causing the curable material to cure to form a dental impression tray as defined above and relesasing the dental impression tray from the mould.

18. (canceled)
